(19) United States
(12) Patent Application Publication
(10) Pub. No.: US 2026/0196151 A1
(43) Pub. Date: Jul. 9, 2026

(54) CHANNEL ANOMALY DETECTION DEVICE AND DISPLAY DEVICE

(71) Applicant: LX SEMICON CO., LTD., Daejeon (KR)

(72) Inventors: Gyeong Hwan KIM, Daejeon (KR); Duck Hwan LEE, Daejeon (KR)

(73) Assignee: LX SEMICON CO., LTD., Daejeon (KR)

(21) Appl. No.: 19/133,010

(22) PCT Filed: Nov. 24, 2023
(86) PCT No.: PCT/KR2023/019162

§ 371 Date: May 27, 2025

(30) Foreign Application Priority Data
Nov. 25, 2022 (KR) 10-2022-0160490
Nov. 24, 2023 (KR) 10-2023- 0165140

(51) Int. Cl. G09G 3/00; G09G 3/36

(52) U.S. Cl. CPC G09G 3/006; G09G 3/3688; G09G 2310/061; G09G 2320/0233; G09G 2330/12; G09G 2380/10

(57) ABSTRACT

A channel anomaly detection device may comprise: a plurality of switches connected to a plurality of data signal output circuits; and a controller that detects channel anomaly on the basis of a sensing signal received through a control with respect to the plurality of data signal output circuits and the plurality of switches. The plurality of data signal output circuits may be included in a plurality of channels connected to a plurality of data lines on a panel.

### TECHNICAL FIELD

Embodiments relate to a channel anomaly detection device and a display device.

### BACKGROUND ART

As informatization progresses, various display devices capable of visualizing information are being developed.

A display device may include a panel having a touch function and a touch driving device. Display devices are adopted in various electronic devices. Display devices execute desired functions or programs in response to a touch on a panel.

On the other hand, display devices are adopted in automobiles. Safety is very important for automobiles. Therefore, display devices adopted in automobiles should also satisfy the automotive ISO26262 safety regulations. As an example, the detection of the presence or absence of an anomaly in each channel of a data driving device of a display device is required.

### Technical Problem

An object of an embodiment is to solve the above-described problems and other problems.

Another object of an embodiment is to provide a channel anomaly detection device and a display device that satisfy the automotive ISO26262 safety regulations.

Additionally, further another object of an embodiment is to provide a channel anomaly detection device and a display device, which are capable of improving reliability.

Technical problems of an embodiment are not limited to those described in this item, but include those that can be understood through the description of the invention.

### Technical Solution to Problem

In order to achieve the above or other objects, according to an aspect of an embodiment, a channel anomaly detection device may include: a plurality of switches connected to a plurality of data signal output circuits; and a controller configured to detect a channel anomaly based on a sensing signal received through control of the plurality of data signal output circuits and the plurality of switches, wherein the plurality of data signal output circuits are included in a plurality of channels connected to a plurality of data lines on a panel.

The controller may be configured to control n pairs of data signal output circuits among the plurality of data signal output circuits to output data signal corresponding to the positive gamma voltages through half of the n pairs of data signal output circuits, and output data signal corresponding to the negative gamma voltages through the remaining half of the n pairs of data signal output circuits, receive a sensing signal generated by turning on at least one of n switches corresponding to the n pairs of data signal output circuits, and detect a channel anomaly based on the received sensing signal.

The controller may be configured to control half of the n pairs of data signal output circuits to output data signal corresponding to the positive gamma voltages and control the remaining half of the n pairs of data signal output circuits to output data signal corresponding to the negative gamma voltages, wherein the positive gamma voltages and the negative gamma voltages are symmetrical to each other with respect to a reference value.

The sensing signal may be an average value of the data signal and the data signal.

The channel anomaly detection device may include an integrator configured to output an output signal based on the sensing signal, wherein the controller may be configured to detect a channel anomaly based on the output signal.

The channel anomaly detection device may include a window comparator connected to the integrator.

The controller may be configured to detect a channel anomaly based on whether the output signal is within a range set by the window comparator.

An upper limit of the set range may be a first code value corresponding to the positive gamma voltages, and a lower limit of the set range may be a second code value corresponding to the negative gamma voltages.

The controller may be configured to detect the channel anomaly during a vertical blank period.

In order to achieve the above or other objects, according to another aspect of an embodiment, a display device includes: a panel including a plurality of gate lines and a plurality of data lines; a data driving device including a plurality of channels connected to the plurality of data lines; and a channel anomaly detection device, wherein the channel anomaly detection device includes: a plurality of switches connected to the plurality of data signal output circuits; and a controller configured to detect a channel anomaly based on a sensing signal received through control of the plurality of data signal output circuits and the plurality of switches.

### Example Advantageous Effects

The effects of the channel anomaly detection device and the display device according to the embodiments are as follows.

According to at least one of the embodiments, data signal corresponding to a gamma voltages output from a plurality of channels of a data driving device may be received as a sensing signal, and an anomaly in each channel or other circuits included in the data driving device may be detected based on the sensing signal. Accordingly, the applicability of the product may be increased by satisfying the automotive ISO26262 safety regulations, and the product reliability may be improved by quickly and accurately detecting anomaly in each channel, etc.

### BRIEF DESCRIPTION OF DRAWINGS

FIG. 1 is a block diagram illustrating a display device according to an embodiment.

FIG. 2 is a configuration diagram illustrating a channel anomaly detection device according to a first embodiment.

FIG. 3 illustrates a vertical synchronization signal of an embodiment.

FIG. 4 illustrates a positive gamma curve and a negative gamma curve of an embodiment.

FIG. 5 is a configuration diagram illustrating a channel anomaly detection device according to a second embodiment.

The sizes, shapes, and dimensions of components illustrated in the drawings may differ from the actual sizes, shapes, and dimensions. In addition, even when the same components are illustrated in different sizes, shapes, and dimensions between the drawings, this is only an example in the drawings, and the same components may have the same sizes, shapes, and dimensions between the drawings.

### DETAILED DESCRIPTION OF EXAMPLE EMBODIMENTS

Hereinafter, embodiments disclosed in the present specification will be described in detail with reference to the accompanying drawings. The same or similar components are denoted by the same reference numerals, regardless of the reference numerals, and redundant descriptions thereof are omitted. The suffixes ‘module’ and ‘unit’ for components used in the following description are assigned or mixed in consideration of easiness in writing the specification and do not have distinctive meanings or roles by themselves. Additionally, the accompanying drawings are used to understanding embodiments disclosed in the present specification, but the technical concept disclosed in the present specification is not limited by the accompanying drawings. Additionally, when a component such as a layer, a region, or a substrate is referred to as being ‘on’ another component, it will be understood that the component may be directly on the other component, or intervening components may be present therebetween.

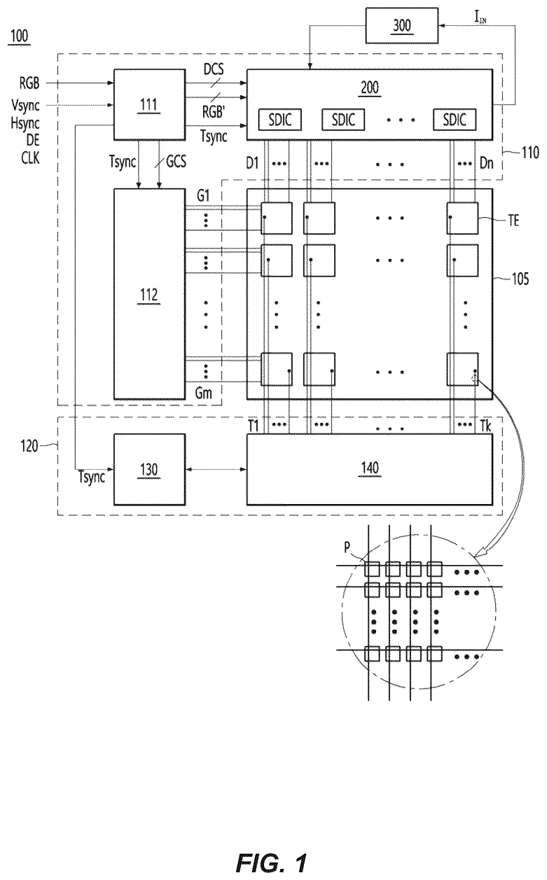

FIG. 1 is a block diagram illustrating a display device according to an embodiment.

Referring to FIG. 1, a display device 100 according to an embodiment may include a panel 105, a display driving device 110, a touch driving device 120, etc.

The display device 100 according to an embodiment may perform a display function and a touch sensing function. The display device 100 according to an embodiment may be implemented as a flat display such as a liquid crystal display.

The panel 105 may include a plurality of touch sensors TE capable of outputting touch sensing signals for touch or proximity of an object.

When the panel 105 is a liquid crystal panel, touch sensing may be performed in an in-cell type. That is, the plurality of touch sensors TE may be embedded into the liquid crystal panel. The liquid crystal panel may be time-divided into a display period and a touch period in units of frames. The plurality of touch sensors TE may be used as common electrodes during the display period and may be used as touch electrodes during the touch period. A plurality of display periods and a plurality of touch periods may be time-divided alternately within one frame.

The in-cell type may be divided into an in-cell type using a self-capacitance type and an in-cell type using a mutual capacitance type.

The panel 105 may include a plurality of gate lines G1 to Gm, a plurality of data lines D1 to Dn, a plurality of pixels P, a plurality of touch sensors TE, a plurality of touch lines T1 to Tk, etc.

Each of the plurality of gate lines G1 to Gm may receive a scan pulse during the display period. Each of the plurality of data lines D1 to Dn may receive a data signal during the display period. The plurality of gate lines G1 to Gm and the plurality of data lines D1 to Dn may be arranged to cross each other on the substrate. The plurality of gate lines G1 to Gm and the plurality of data lines D1 to Dn may be respectively connected to the plurality of pixels P on the substrate. The plurality of pixels P may respectively include thin film transistors connected to the gate lines G1 to Gm and the data lines D1 to Dn, the pixels P electrodes connected to the thin film transistors, storage capacitors connected to the pixels P electrode, etc.

Since each of the plurality of touch sensors TE is used as a self-capacitance type touch sensor during the touch period, each of the plurality of touch sensors TE may have a size larger than a minimum contact size between the touch object and the panel 105. For example, the size of the touch sensor TE may correspond to the size of one pixel P, or may correspond to the size of the plurality of pixels P. The plurality of touch sensors TE may be arranged along a plurality of horizontal lines and a plurality of vertical lines. The plurality of touch lines T1 to Tk may be individually connected to the plurality of touch sensors TE, but the present disclosure is not limited thereto.

The display driving device 110 may supply data signals to the plurality of pixels P so that an image is displayed on the panel 105 during the display period. The display driving device 110 may include a data processing device 111, a gate driving device 112, a data driving device 200, etc. The data processing device 111 may include a timing controller.

The data processing device 111 may receive various timing signals from a host system. The timing signals may include a vertical synchronization signal Vsync, a horizontal synchronization signal Hsync, a data enable signal DE, a clock signal CLK, etc. The data processing device 111 may generate various control signals based on the timing signals.

For example, the control signals may generate a gate control signal GCS for controlling the gate driving device 112 and a data control signal DCS for controlling the data driving device 200. The data processing device 111 may receive an image signal, i.e., digital image data RGB, from the host system and convert the image signal into an image signal RGB′ in a form that may be processed by the data driving device 200.

The data processing device 111 may generate a touch synchronization signal Tsync by using the clock signal CLK, the vertical synchronization signal Vsync, the data enable signal, etc. The data processing device 111 may transmit the touch synchronization signal Tsync to the gate driving device 112, the data driving device 200, the touch controller 130, etc.

In the in-cell type, each of the gate driving device 112, the data driving device 200, and the touch controller 130 may time-divide the plurality of display periods and the plurality of touch periods by using the touch synchronization signal Tsync. For example, the display periods and the touch periods may be allocated so that the display periods and the touch periods are positioned alternately.

Alternatively, the data processing device 111 may time-divide the plurality of display periods and the plurality of touch periods by using the touch synchronization signal Tsync. In this case, instead of the touch synchronization signal Tsync, the data processing device 111 may transmit control signals regarding the plurality of time-divided display periods and the plurality of time-divided touch periods to each of the gate driving device 112, the data driving device 200, and the touch controller 130.

The host system converts the digital image data RGB into the image signal RGB′ having a format suitable for display on the panel 105. The host system may transmit the timing signals Vsync, Hsync, DE, and CLK together with the image signal RGB′ to the data processing device 111. The host system may be implemented as a television system, a set-top box, a navigation system, a DVD player, a Blu-ray player, a personal computer (PC), a home theater system, a mobile system, an automotive, marine or aviation electronic system, etc.

On the other hand, the host system may receive touch input coordinates from the touch driving device 120 and execute an application program linked to the received touch input coordinates or perform a corresponding operation.

The gate driving device 112 may receive the gate control signal GCS from the data processing device 111 during the display period. The gate driving device 112 may generate a scan pulse in response to the gate control signal GCS. The scan pulse may be provided to the corresponding pixels P of the panel 105 through the corresponding gate lines G1 to Gm.

The gate driving device 112 supplies the scan pulse to the gate lines G1 to Gm during the display period, but may not supply the scan pulse to the gate lines G1 to Gm during the touch period. That is, the gate lines G1 to Gm may be maintained at a high level during the display period, and the gate lines G1 to Gm may be maintained at a low level during the touch period. Accordingly, the scan pulse is supplied during the display period to select the pixels P connected to the corresponding gate lines G1 to Gm, and the gate lines G1 to Gm are maintained at a low level during the touch period to prevent fluctuations in the output of the touch sensors TE.

The data driving device 200 may receive the data control signal DCS and the image signal RGB′ from the data processing device 111 during the display period. The data driving device 200 may convert the image signal RGB′ into an analog data signal by using the data control signal DCS and supply the data signal to pixels P through the plurality of data lines D1 to Dn.

The data driving device 200 may include a plurality of source drive integrated circuits SDIC. One source drive integrated circuit SDIC may be connected to the plurality of data lines D1 to Dn, and thus, one source drive integrated circuit SDIC may supply the plurality of data signals to the panel 105 through the plurality of data lines D1 to Dn.

The touch driving device 120 may include a touch controller 130, a touch sensing circuit 140, etc. The touch controller 130 may be referred to as a touch microcontroller unit, etc.

The touch controller 130 may perform the touch sensing operation during the touch period. The touch controller 130 may control the touch sensing circuit 140 to perform the touch sensing operation during the touch period.

The touch controller 130 may obtain touch coordinates based on the touch sensing signal received through the touch sensing circuit 140 and execute an application program corresponding to the touch coordinates or perform a corresponding operation. The touch controller 130 may transmit information including the corresponding touch coordinates to the data processing device 111. In this case, the data processing device 111 may execute an application corresponding to the touch coordinates or perform a corresponding operation, based on information including the touch coordinates received from the touch controller 130.

On the other hand, the channel anomaly detection device 300 may detect an anomaly in the data driving device 200 based on a sensing signal I_{IN} received from the data driving device 200. For example, the channel anomaly detection device 300 may detect an anomaly in a plurality of channels of the data driving device 200 based on a sensing signal I_{IN} received from the data driving device 200. For example, the channel anomaly detection device 300 may detect an anomaly in various circuits, such as a data signal output circuit and a gamma voltage output circuit, which are included in each of the plurality of channels and involved in the generation of the data signal based on the sensing signal I_{IN} received from the data driving device 200.

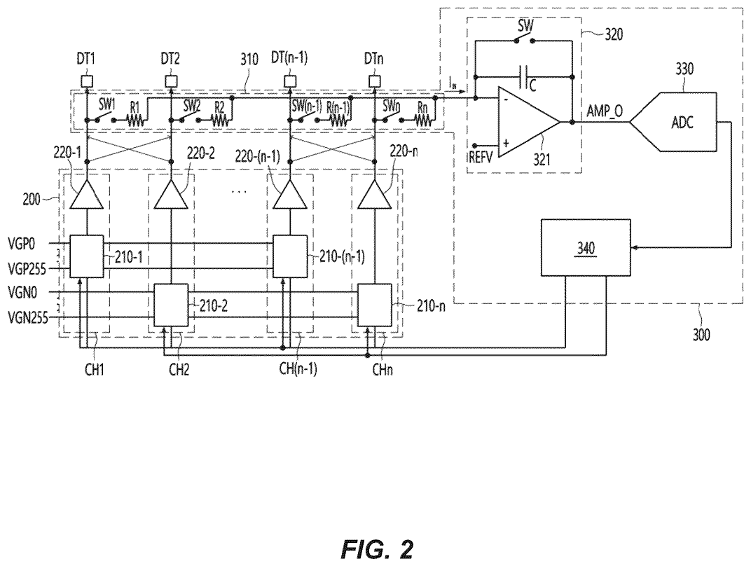

FIG. 2 is a configuration diagram illustrating the channel anomaly detection device according to a first embodiment.

Referring to FIGS. 1 and 2, the data driving device 200 may include a plurality of channels CH1 to CHn. The plurality of channels CH1 to CHn may be connected to a plurality of data lines D1 to Dn on a panel 105 through a plurality of data terminals DT1 to DTn, respectively.

When the panel 105 is a liquid crystal panel, a plurality of data signals supplied to the plurality of data lines D1 to Dn on the panel 105 may be generated by using positive gamma voltages VGP0 to VGP255 or negative gamma voltage VGN0 to VGN255.

The polarities of the plurality of data signals supplied to the plurality of data lines D1 to Dn may be reversed in units of adjacent channels by using the positive gamma voltages VGP0 to VGP255 or the negative gamma voltages VGN0 to VGN255, and may be reversed in units of frames. For example, during a first frame, data signal (hereinafter referred to as first data signals) corresponding to the positive gamma voltages VGP0 to VGP255 may be output through odd-numbered data terminals D11, DT3, . . . , DT(n−1), and data signals (hereinafter referred to as second data signals) corresponding to the negative gamma voltages VGN0 to VGN255 may be output through even-numbered data terminals D2, D4, . . . , DTn. For example, during a second frame, second data signals may be output through the odd-numbered data terminals D11, DT3, . . . , DT(n−1), and first data signals may be output through the even-numbered data terminals D2, D4, . . . , DTn. To this end, a switching unit including at least one switch that changes a channel path between the adjacent channels may be provided.

On the other hand, the plurality of channels CH1 to CHn may include a plurality of data signal output circuits 210-1 to 210-n, a plurality of buffers 220-1 to 220-n, etc. The data signal output circuits 210-1 to 210-n and the plurality of buffers 220-1 to 220-n may include digital-to-analog converters DAC, decoders, etc. The buffers 220-1 to 220-n may serve to stably supply the output signals of the data signal output circuits 210-1 to 210-n, i.e., the data signals, to the panel 105 without loss.

Each of the plurality of data signal output circuits 210-1 to 210-n may output a data signal. The plurality of data signal output circuits 210-1 to 210-n may generate data signals by using the positive gamma voltages VGP0 to VGP255 and the negative gamma voltages VGN0 to VGN255, and may output the generated data signals to the corresponding data terminals DT1 to DTn through the corresponding buffers 220-1 to 220-n.

The positive gamma voltages VGP0 to VGP255 and the negative gamma voltages VGN0 to VGN255 may be preset or generated in real time based on a positive gamma curve (P-Gamma) and a negative gamma curve (N-Gamma), as illustrated in FIG. 4. To this end, a gamma voltage output circuit may be provided to generate the positive gamma voltages VGP0 to VGP255 and the negative gamma voltages VGN0 to VGN255. The gamma voltage output circuit may be referred to as a gamma unit, a gamma circuit, a gamma voltage setting circuit, a gamma voltage generation circuit, a gamma voltage output circuit, etc.

The positive gamma curve (P-Gamma) may include the positive gamma voltages VGP0 to VGP255 according to grayscale. The negative gamma curve (N-Gamma) may include the negative gamma voltages VGN0 to VGN255 according to grayscale.

In the positive gamma curve (P-Gamma), the positive gamma voltages VGP0 to VGP255 may be generated between a first power supply voltage PVDD and a reference value REFV. In the negative gamma curve (N-Gamma), the negative gamma voltages VGN0 to VGN255 may be generated between the reference value REFV and a second power supply voltage NVDD. The reference value REFV may be OV, but is not limited thereto. The first power supply voltage PVDD may be higher than the second power supply voltage NVDD, and the potential difference between the first power supply voltage PVDD and the reference value REFV may be equal to the potential difference between the reference value REFV and the second power supply voltage NVDD.

As illustrated in FIG. 4, as the grayscale value increases in the positive gamma curve (P-Gamma), the positive gamma voltages VGP0 to VGP255 may nonlinearly increase between the first power supply voltage PVDD and the reference value REFV. As the grayscale value increases in the negative gamma curve (N-Gamma), the negative gamma voltages VGN0 to VGN255 may nonlinearly decrease between the reference value REFV and the second power supply voltage NVDD.

At this time, the positive gamma voltages VGP0 to VGP255 and the negative gamma voltages VGN0 to VGN255 may be symmetrical to each other with respect to the reference value REFV. When the reference value REFV is 0 V, the sum of the positive gamma voltages VGP0 to VGP255 and the negative gamma voltages VGN0 to VGN255 at a specific grayscale may be 0. For example, for a 70th grayscale, the positive gamma voltage VGP70 may be +3 V and the negative gamma voltage VGN70 may be −3 V. For example, for a 163th grayscale, the positive gamma voltage VGP163 may be +4 V and the negative gamma voltage VGN163 may be −4 V.

By utilizing this symmetry principle, the same grayscale may be expressed in the pixels P by supplying the positive gamma voltages VGP0 to VGP255 and the negative gamma voltages VGN0 to VGN255, which are symmetrical to each other, to the pixels P connected to the corresponding data lines D1 to Dn.

On the other hand, an anomaly may occur in the data driving device 200 including the data signal output circuits 210-1 to 210-n, the buffers 220-1 to 220-n, the gamma voltage output circuit, and other circuits due to various causes such as noise, electromagnetic waves, or shock. In this case, the first data signal and the second data signal, which are symmetrical to each other in order to express the same grayscale, may be output with a larger or smaller value due to an anomaly in the data driving device 200. Accordingly, the same grayscale expression may not be achieved, resulting in non-uniform luminance.

For example, in order to obtain luminance corresponding to the same grayscale, a first data signal VGP200 and a second data signal VGN200 corresponding to a 200th grayscale may be alternately supplied to the plurality of data lines D1 to Dn on the panel 105. At this time, an anomaly may occur in the data driving device 200 including the data signal output circuits 210-1 to 210-n, the buffers 220-1 to 220-n, the gamma voltage output circuit, and other circuits. In this case, the first data signal VGP200 may be changed to a larger value so that a first data signal VGP240 corresponding to a 240th grayscale may be supplied, or the second data signal VGN200 may be changed to a lower value so that a second data signal VGN170 corresponding to a 170th grayscale may be supplied. Accordingly, due to an anomaly in the data driving device 200, the first data signal VGP240 corresponding to the 240th grayscale and the second data signal VGN170 corresponding to the 170th grayscale are supplied, so that non-uniform luminance may be obtained. Therefore, even when intending to obtain uniform luminance through the same grayscale, non-uniform luminance may be obtained, resulting in a deterioration in image quality and lowering product reliability.

Therefore, it is urgent to accurately detect an anomaly in the data driving device 200 including not only the plurality of channels CH1 to CHn but also the gamma voltage output circuit, other circuits, etc., at an early stage.

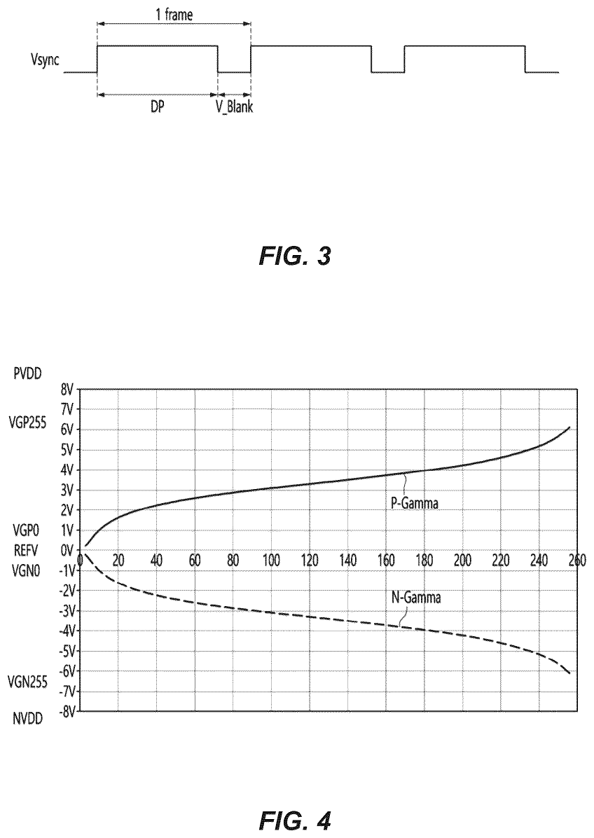

On the other hand, as illustrated in FIG. 3, the vertical synchronization signal Vsync may include a display period DP and a vertical blank period V_Blank. A frame may be defined by the display period DP and the vertical blank period V_Blank.

For each frame, an image may be displayed during the display period DP. The vertical blank period V_Blank may be a period during which no data signal is output for a certain period of time after the data signal is output to pixels P on the last gate line G1 to Gm of the frame and before the data signal is output to the pixels P on the first gate line G1 to Gm of the next frame.

The channel anomaly detection device 300 according to the first embodiment may be performed for each detection period. The detection period may be allocated to all or part of the vertical blank period V_Blank. A plurality of detection periods may be allocated to the vertical blank period V_Blank, and the operation of the channel anomaly detection device 300 according to the first embodiment may be performed in each of the plurality of detection periods.

The channel anomaly detection device 300 according to the first embodiment may include a plurality of switches SW1 to SWn, a controller 340, etc.

The plurality of switches SW1 to SWn may be connected to the plurality of channels CH1 to CHn, respectively. The plurality of switches SW1 to SWn may be connected to the plurality of data signal output circuits 210-1 to 210-n, respectively. The plurality of switches SW1 to SWn may be connected to the plurality of buffers 220-1 to 220-n, respectively.

The controller 340 may control the plurality of data signal output circuits 210-1 to 210-n and the plurality of switches SW1 to SWn to detect a channel anomaly at each detection period. The controller 340 may detect a channel anomaly based on a sensing signal I_{IN} received through the control of the plurality of data signal output circuits 210-1 to 210-n and the plurality of switches SW1 to SWn. Hereinafter, the channel anomaly may refer to an anomaly in not only the channels CH1 to CHn but also various circuits included in the data driving device 200 and involved in generating data signals.

The controller 340 may control n pairs of data signal output circuits among the plurality of data signal output circuits 210-1 to 210-n to output a first data signal and a second data signal through the n pairs of data signal output circuits.

The controller 340 may cause half of the n pairs of data signal output circuits to output the first data signal, and the other half of the n pairs of data signal output circuits to output the second data signal. For example, the channel anomaly detection operation may be performed on two channels CH1 to CH2 among ten channels CH1 to CH10. For example, the channel anomaly detection operation may be performed on six channels CH1 to CH6 among ten channels CH1 to CH10.

The controller 340 may turn on the n switches SW1 to SWn corresponding to the n pairs of data signal output circuits to receive the sensing signal I_{IN} including the first data signal and the second data signal through n switches SW1 to SWn. The controller 340 may detect a channel anomaly based on the received sensing signal I_{IN}. The sensing signal I_{IN} may have a current value, but is not limited thereto.

As an example, the controller 340 may control, for example, the first data signal output circuit 210-1 and the second data signal output circuit 210-2 among the ten data signal output circuits 210-1 to 210-10 of the ten channels CH1 to CH10 to output the first data signal from the first data signal output circuit 210-1 and the second data signal from the second data signal output circuit 210-2. For example, the first data signal and the second data signal are signals having the same grayscale and may have the same potential difference with respect to the reference value REFV. The controller 340 may turn on the first switches SW1 to SWn and the second switches SW1 to SWn to receive the sensing signal I_{IN} including the first data signal output from the first data signal output circuit 210-1 and the second data signal output from the second data signal output circuit 210-2. For example, the sensing signal I_{IN} may be an average value of the first data signal and the second data signal. Since the first data signal and the second data signal have the same potential difference with respect to the reference value REFV, the average value of the first data signal and the second data signal, i.e., the sensing signal I_{IN}, may be 0.

The controller 340 may detect an anomaly in the first channel CH1 and/or the second channel CH2 based on the sensing signal I_{IN}. When the sensing signal I_{IN} is 0, the controller 340 may detect that the first channel CH1 and/or the second channel CH2 are/is normal. When an anomaly occurs in the first channel CH1 and/or the second channel CH2, the first data signal or the second data signal may be changed. In this case, the average value of the first data signal and the second data signal, i.e., the sensing signal I_{IN}, may be a value greater than 0. Accordingly, when the sensing signal I_{IN} is a value greater than 0, the controller 340 may detect that the first channel CH1 and/or the second channel CH2 are/is abnormal.

As another example, the controller 340 may control, for example, the first to sixth data signal output circuits 210-1 to 210-6 among the ten data signal output circuits 210-1 to 210-10 of the ten channels CH1 to CH10. Accordingly, the first data signal may be output from each of the first data signal output circuit 210-1, the third data signal output circuit 210-3, and the fifth data signal output circuit 210-5. The second data signal may be output from each of the second data signal output circuit 210-2, the fourth data signal output circuit 210-4, and the sixth data signal output circuit 210-6. For example, the first data signal and the second data signal are signals having the same grayscale and may have the same potential difference with respect to the reference value REFV.

The controller 340 may turn on the first to sixth switches SW1 to SW6 to receive the sensing signal I_{IN} including the first data signal output from the first, third, and fifth data signal output circuits 210-1, 210-3, and 210-5 and the second data signal output from the second, fourth, and sixth data signal output circuits 210-2, 210-4, and 210-6. The controller 340 may detect an anomaly in all or part of the first to sixth channels CH1 to CH6 based on the sensing signal I_{IN}. When the sensing signal I_{IN} is 0, the controller 340 may detect that all or part of the first to sixth channels CH1 to CH6 are normal. When an anomaly occurs in all or part of the first to sixth channels CH1 to CH6, the first data signal or the second data signal may be changed. In this case, the average value of the first data signal and the second data signal, i.e., the sensing signal I_{IN}, may be a value greater than 0. Accordingly, when the sensing signal I_{IN} is a value greater than 0, the controller 340 may detect that all or part of the first to sixth channels CH1 to CH6 are abnormal.

On the other hand, the channel anomaly detection device 300 according to the first embodiment may include an integrator 320, an analog-to-digital converter (ADC) 330, etc.

The integrator 320 may be commonly connected to the plurality of switches SW1 to SWn. The integrator 320 may include an amplifier 321, a capacitor C, a switch SW, etc.

The plurality of switches SW1 to SWn may be connected to an inverting (−) terminal of the amplifier 321, and a reference value REFV may be input to a non-inverting (+) terminal of the amplifier 321. The reference value REFV may be the reference value REFV illustrated in FIG. 4. The amplifier 321 may integrate and output the sensing signal I_{IN}. An output signal AMP_O output from the amplifier 321 may be a voltage signal, but is not limited thereto. For example, when the sensing signal I_{IN} is 0, the output signal AMP_O of the amplifier 321 may also become 0, and when the sensing signal I_{IN} is not 0, the output signal AMP_O of the amplifier 321 may have a value greater than 0.

On the other hand, the switch SW may initiate the voltage charged in the capacitor C. The switch SW may be initiated at each detection period.

The ADC 330 may convert the output signal AMP_O of the amplifier 321 into a digital signal and transmit the converted digital signal to the controller 340. When the output signal AMP_O of the amplifier 321 is 0, the output signal of the ADC 330 may also be 0. When the output signal AMP_O of the amplifier 321 is a value greater than 0, the output signal of the ADC 330 may also have a binary value greater than 0.

The controller 340 may detect a channel anomaly based on the digital signal received from the ADC 330. When the digital signal is 0, the controller 340 may detect that the channels CH1 to CHn are normal. When the digital signal has a binary value greater than 0, the controller 340 may detect that the channels CH1 to CHn are abnormal.

On the other hand, when the controller 340 detects an anomaly in the data driving device 200, including a channel anomaly, the controller 340 may transmit the corresponding detection information to the data processing device 111. The data processing device 111 may initialize the display device 100 or take other actions to resolve the channel anomaly. In another embodiment, when the controller 340 detects an anomaly of the data driving device 200, including a channel anomaly, the controller 340 may initialize the gamma voltage output circuit and the data signal output circuits 210-1 to 210-n within the corresponding channels CH1 to CHn or may take other measures to resolve the channel anomaly. In addition to this, when a channel anomaly is detected, necessary measures may be taken to ensure the normal operation of the corresponding channels CH1 to CHn by using various methods.

According to the first embodiment, a channel anomaly may be performed in units of n channels so that a channel anomaly is detected simply by determining whether the sensing signal I_{IN} is 0. Accordingly, a channel anomaly may be easily detected through a simple circuit configuration without computational burden, thereby improving the product reliability and satisfying the automotive ISO26262 safety regulations.

On the other hand, the first embodiment was limited so that the channel anomaly was performed in units of n pairs of channels. However, there is a need to develop a technology that is capable of detecting a channel anomaly not only in units of n pairs of channels, but also in units of one channel, an odd number of channels, or a random number of channels. A second embodiment described below extends the limited implementation scope of the first embodiment to enable detection of a channel anomaly in a variety of ranges.

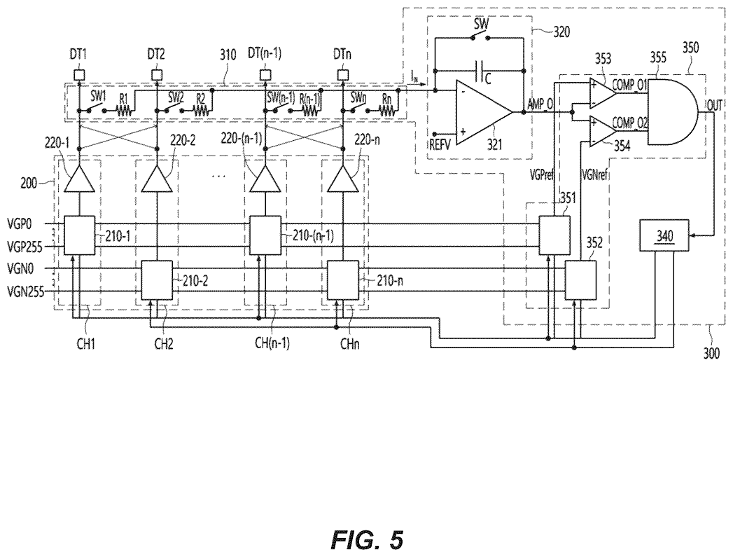

FIG. 5 is a configuration diagram illustrating a channel anomaly detection device according to a second embodiment.

Referring to FIGS. 1 and 5, a channel anomaly detection device 300 according to a second embodiment may include a plurality of switches SW1 to SWn, an integrator 320, a window comparator 350, a controller 340, etc. A plurality of resistors R1 to Rn may be respectively connected to the plurality of switches SW1 to SWn.

Since the plurality of switches SW1 to SWn and the integrator 320 have been described in the first embodiment, a detailed description thereof is omitted.

The window comparator 350 may output an output signal OUT according to whether a sensing signal I_{IN} received through the plurality of switches SW1 to SWn is within a set range. For example, when the sensing signal I_{IN} is within the set range, the window comparator 350 may output a high-level output signal OUT. For example, when the sensing signal I_{IN} is out of the set range, the window comparator 350 may output a low-level output signal OUT. The upper limit of the set range may be a first code value corresponding to positive gamma voltages VGP0 to VGP255, and the lower limit of the set range may be a second code value corresponding to negative gamma voltages VGN0 to VGN255. At this time, the first code value and the second code value may each be a current value, but are not limited thereto. The controller 340 may detect a channel anomaly based on the output signal OUT of the window comparator 350.

When the integrator 320 is connected between the plurality of switches SW1 to SWn and the window comparator 350, an output signal AMP_O of the integrator 320 is input to the window comparator 350. Accordingly, the window comparator 350 may output the output signal OUT according to whether the output signal AMP_O of the integrator 320 is within a set range. For example, when the output signal AMP_O of the integrator 320 is within the set range, the window comparator 350 may output a high-level output signal OUT. For example, when the output signal AMP_O of the integrator 320 is out of the set range, the window comparator 350 may output a low-level output signal OUT. The upper limit of the set range may be a first code value corresponding to positive gamma voltages VGP0 to VGP255, and the lower limit of the set range may be a second code value corresponding to negative gamma voltages VGN0 to VGN255. At this time, the first code value and the second code value may each be a voltage value, but are not limited thereto. The controller 340 may detect a channel anomaly based on the output signal OUT of the window comparator 350.

The window comparator 350 may include an upper limit output circuit 351, a lower limit output circuit 352, a first comparator 353, a second comparator 354, an AND gate element 355, etc.

The upper limit output circuit 351 may output the first code value corresponding to the positive gamma voltages VGP0 to VGP255 as the upper limit of the set range. The lower limit output circuit 352 may output the second code value corresponding to the negative gamma voltages VGN0 to VGN255 as the lower limit of the set range.

The upper limit output circuit 351 may be the first data signal output from the data signal output circuits 210-1 to 210-n of the channels CH1 to CHn on which an anomaly detection is currently performed, but is not limited thereto. The lower limit output circuit 352 may be the second data signal output from the data signal output circuits 210-1 to 210-n of the channels CH1 to CHn on which an anomaly detection is currently performed, but is not limited thereto.

For example, the controller 340 may control the first to third data signal output circuits 210-1 to 210-3 and the first to third switches SW1 to SW3 of the first to third channels CH1 to CH3 during the detection period. Accordingly, the first data signal output circuit 210-1 and the third data signal circuit 210-3 may output the first data signal, and the second data signal output circuit 210-2 may output the second data signal. Here, the first data signal and the second data signal are signals having the same grayscale and may have the same potential difference with respect to the reference value REFV. The controller 340 may turn on the first to third switches SW1 to SW3 so that the sensing signal I_{IN} from the first to third data signal output circuits 210-1 to 210-3 through the first to third switches SW1 to SW3 may be input to the integrator 320. The output signal AMP_O of the integrator 320 may be input to an inverting (−) terminal of the first comparator 353 and a non-inverting (+) terminal of the second comparator 354.

The controller 340 may control the upper limit output circuit 351 so that the first code value corresponding to the positive gamma voltages VGP0 to VGP255 may be output from the upper limit output circuit 351 as the upper limit of the set range. The first code value corresponding to the positive gamma voltages VGP0 to VGP255 may be generated from the positive gamma voltages VGP0 to VGP255 that are the same as the first data signals output from the first data signal output circuit 210-1 and the third data signal output circuit 210-3. The first code value may be input to the non-inverting (+) terminal of the first comparator 353.

The controller 340 may control the lower limit output circuit 352 so that the second code value corresponding to the negative gamma voltages VGN0 to VGN255 may be output from the lower limit output circuit 352 as the lower limit of the set range. The second code value corresponding to the negative gamma voltages VGN0 to VGN255 may be generated from the negative gamma voltages VGN0 to VGN255 that are the same as the second data signal output from the second data signal output circuit 210-2. The second code value may be input to the inverting (−) terminal of the second comparator 354.

In this case, the outputs of the first comparator 353, the second comparator 354, and the AND gate element 355 may be shown in Table 1.

TABLE 1

| | COMP_{—} | COMP_{—} | |
|---|---|---|---|
| Conditions | O1 | O2 | OUT |
| VGNref < AMP_O, VGPref < AMP_O | L | H | L |
| VGNref < AMP_O < GPref | H | H | H |
| AMP_O < VGNref, AMP_O < VGPref | H | L | L |

According to the first condition, when the output signal AMP_O of the integrator 320 is greater than the first code value VGPref, the first comparator 353 may output the low-level output signal COMP_O1. When the output signal AMP_O of the integrator 320 is greater than the second code value VGNref, the second comparator 354 may output the high-level output signal COMP_O2. In this case, the AND gate element 355 may output the low-level output signal OUT by performing an AND gate operation on the low-level output signal COMP_O1 output from the first comparator 353 and the high-level output signal COMP_O2 output from the second comparator 354. According to the second condition, when the output signal AMP_O of the integrator 320 is less than the first code value VGPref, the first comparator 353 may output the high-level output signal COMP_O1. When the output signal AMP_O of the integrator 320 is greater than the second code value VGNref, the second comparator 354 may output the high-level output signal COMP_O2. In this case, the AND gate element 355 may output the high-level output signal OUT by performing an AND gate operation on the high-level output signal COMP_O1 output from the first comparator 353 and the high-level output signal COMP_O2 output from the second comparator 354.

According to the third condition, when the output signal AMP_O of the integrator 320 is less than the first code value VGPref, the first comparator 353 may output the high-level output signal COMP_O1. When the output signal AMP_O of the integrator 320 is less than the second code value VGNref, the second comparator 354 may output the low-level output signal COMP_O2. In this case, the AND gate element 355 may output the low-level output signal OUT by performing an AND gate operation on the high-level output signal COMP_O1 output from the first comparator 353 and the low-level output signal COMP_O2 output from the second comparator 354.

As shown in Table 1, when the output signal AMP_O of the integrator 320 is within the set range, the window comparator 350 may output a high-level output signal OUT. For example, when the output signal AMP_O of the integrator 320 is located between the first code value VGPref and the second code value VGNref, the window comparator 350 may output the high-level output signal OUT. In contrast, when the output signal AMP_O of the integrator 320 is out of the set range, the window comparator 350 may output a low-level output signal OUT. For example, when the output signal AMP_O of the integrator 320 is greater than the first code value VGPref or less than the second code value VGNref, the window comparator 350 may output the low-level output signal OUT.

Although not shown, the output signal OUT output from the window comparator 350 may be converted into a digital signal by the ADC 330, and then the presence or absence of a channel anomaly may be detected by the controller 340. For example, when the high-level output signal OUT is output from the window comparator 350, the controller 340 may detect that the channels CH1 to CHn are normal. For example, when the low-level output signal OUT is output from the window comparator 350, the controller 340 may detect that the channels CH1 to CHn are abnormal.

According to the second embodiment, the product applicability may be increased by detecting a channel anomaly not only in units of n pairs of channels but also in units of one channel, an odd number of channel units, or a random number of channel units.

On the other hand, by controlling a specific data signal output circuit and/or a specific switch to operate only a specific channel CH1 or a pair of channels CH1 and CH2, an anomaly detection for a specific channel data signal output circuit(s) is possible. In addition, when using the internal ADC (330 of FIG. 2), an anomaly in the positive gamma voltages or the negative gamma voltages themself may also be detected. At this time, the switches SW1 to SWn may be turned on/off simultaneously or sequentially.

The above detailed description should not be construed as limiting in any respect and should be considered illustrative only. The scope of the embodiment should be determined by the reasonable interpretation of the appended claims, and any changes within the equivalent range of the embodiment fall within the scope of the embodiment.

1. A channel anomaly detection device comprising:
a plurality of switches connected to a plurality of data signal output circuits; and
a controller configured to detect a channel anomaly based on a sensing signal received through control of the plurality of data signal output circuits and the plurality of switches,
wherein the plurality of data signal output circuits are included in a plurality of channels connected to a plurality of data lines on a panel.

2. The channel anomaly detection device of claim 1, wherein the controller is configured to:
control n pairs of data signal output circuits among the plurality of data signal output circuits to output data signal corresponding to positive gamma voltages through half of the n pairs of data signal output circuits, and output data signal corresponding to negative gamma voltages through a remaining half of the n pairs of data signal output circuits;
receive a sensing signal generated by turning on at least one of n switches corresponding to the n pairs of data signal output circuits; and
detect a channel anomaly based on the received sensing signal.

3. The channel anomaly detection device of claim 2, wherein the positive gamma voltages and the negative gamma voltages are symmetrical to each other with respect to a reference value.

4. The channel anomaly detection device of claim 2, wherein the sensing signal is an average value of the data signal and the data signal.

5. The channel anomaly detection device of claim 1, comprising an integrator configured to output an output signal based on the sensing signal,
wherein the controller is configured to detect a channel anomaly based on the output signal.

6. The channel anomaly detection device of claim 5, comprising a window comparator connected to the integrator.

7. The channel anomaly detection device of claim 6, wherein the controller is configured to detect a channel anomaly based on whether the output signal is within a range set by the window comparator.

8. The channel anomaly detection device of claim 7, wherein an upper limit of the set range is a first code value corresponding to the positive gamma voltages, and
wherein a lower limit of the set range is a second code value corresponding to the negative gamma voltages.

9. The channel anomaly detection device of claim 1, wherein the controller is configured to detect the channel anomaly during a vertical blank period.

10. A display device comprising:
a panel comprising a plurality of gate lines and a plurality of data lines;
a data driving device comprising a plurality of channels connected to the plurality of data lines; and
a channel anomaly detection device,
wherein the channel anomaly detection device comprises:
a plurality of switches connected to a plurality of data signal output circuits; and
a controller configured to detect a channel anomaly based on a sensing signal received through control of the plurality of data signal output circuits and the plurality of switches.

11. The display device of claim 10, wherein the plurality of data signal output circuits are included in the plurality of channels connected to the plurality of data lines on the panel.

12. The display device of claim 10, wherein the controller is configured to:
control n pairs of data signal output circuits among the plurality of data signal output circuits to output data signal corresponding to positive gamma voltages through half of the n pairs of data signal output circuits, and output data signal corresponding to negative gamma voltages through a remaining half of the n pairs of data signal output circuits;
receive a sensing signal generated by turning on at least one of n switches corresponding to the n pairs of data signal output circuits; and
detect a channel anomaly based on the received sensing signal.

13. The display device of claim 12, wherein the positive gamma voltages and the negative gamma voltages are symmetrical to each other with respect to a reference value.

14. The display device of claim 12, wherein the sensing signal is an average value of the data signal and the data signal.

15. The display device of claim 11, comprising an integrator configured to output an output signal based on the sensing signal,
wherein the controller is configured to detect a channel anomaly based on the output signal.

16. The display device of claim 15, comprising a window comparator connected to the integrator.

17. The display device of claim 16, wherein the controller is configured to detect a channel anomaly based on whether the output signal is within a range set by the window comparator.

18. The display device of claim 17, wherein an upper limit of the set range is a first code value corresponding to positive gamma voltages, and
wherein a lower limit of the set range is a second code value corresponding to negative gamma voltages.

19. The display device of claim 11, wherein the controller is configured to detect the channel anomaly during a vertical blank period.
